(19) United States
(12) Patent Application Publication
(10) Pub. No.: US 2017/0326925 A1
(43) Pub. Date: Nov. 16, 2017

(54) TYRE COMPRISING A FOAM MATERIAL FOR ACOUSTIC ABSORPTION

(71) Applicant: BRIDGETONE CORPORATION, Tokyo (JP)

(72) Inventors: Pasquale AGORETTI, Ariccia (IT); Michele AMURRI, Roma (IT)

(73) Assignee: BRIDGESTONE CORPORATION, Tokyo (JP)

(21) Appl. No.: 15/526,484

(22) PCT Filed: Nov. 13, 2015
(86) PCT No.: PCT/IB2015/058787

§ 371 Date: May 12, 2017

(30) Foreign Application Priority Data
Nov. 13, 2014 (IT) RM2014A000667

(51) Int. Cl. B60C 19/00; B60C 5/14

(52) U.S. Cl. CPC B60C 19/002; B60C 5/14; B60C 2005/145

(57) ABSTRACT

A tyre comprising an impermeable layer designed to ensure the sealing under pressure of the air contained in the inner cavity of the carcass and a foam material provided on the inside of said inner cavity, wherein the foam material is made up of open cell foam with a cell size or diameter of from 150 to 190 μm and a standard deviation of 5% to 15%.

### TECHNICAL FIELD

The present invention concerns a tyre comprising a foam material for acoustic absorption. More precisely, the present invention concerns a tyre comprising a foam material housed in the inner cavity covered in an air-impermeable layer and filled with air under pressure.

### BACKGROUND ART

One of the noises produced by a tyre when running is the sound of the cavity resonance generated by the vibrations of the air under pressure present in the inner cavity of the tyre. To abate this type of noise, the use of foam materials applied to the surface of the impermeable layer of the tyre inner cavity has been known for some time.

In this regard it should be said that the frequencies in the range between 180 and 300 Hz are those that mainly characterise the cavity resonance sound generated by the vibrations of the air under pressure, and they are perceived mostly inside the vehicle.

The foam materials commonly used for this purpose have the drawback of not being very effective in the absorption of acoustic waves in the above-mentioned frequency range.

The need was therefore felt for a foam material which is effective especially in the absorption of acoustic waves at a frequency ranging from 180 to 300 Hz.

The Applicant has found that a foam material consisting mainly of open cells having an average size ranging from 150 to 190 μm with a standard deviation ranging from 5 to 15%, is able to ensure improved absorption of acoustic waves at frequencies ranging from 180 to 300 Hz.

In particular, it has been verified that if the average dimensions of the cells comply with the condition relative to the dimension (average size ranging from 150 to 190 μm) but with a standard deviation greater than 15%, the advantages in terms of acoustic absorption cannot be considered satisfactory. In other words, the inventors of the present invention have found that a fundamental parameter for obtaining the advantages sought in terms of acoustic absorption is that at least 85% of the cells have a size ranging from 150 to 190 μm.

### DISCLOSURE OF INVENTION

The subject of the present invention is a tyre comprising an impermeable layer designed to ensure sealing under pressure of the air contained in the inner cavity of the carcass and a foam material housed inside said inner cavity, preferably at least in an area below a respective tread band; said tyre being characterised in that said foam material has a porosity consisting of open cells having an average size ranging from 150 to 190 μm with a standard deviation ranging from 5% to 15%.

Preferably, said foam material has a density ranging from 10 to 15 Kg/m³.

Preferably, said foam material is made of polyurethane, more preferably polyester-based or polyether-based polyurethane.

Preferably, the foam material occupies a volume ranging from 0.1 to 100% of the volume of the inner cavity. More preferably, the foam material has a thickness ranging from 10 to 200 mm and a width ranging from 10 to 100% of the width of the inner cavity.

Preferably, the foam material occupies a volume ranging from 0.4 to 20% of the volume of the inner cavity. More preferably, the foam material has a thickness ranging from 20 to 30 mm and a width ranging from 20 to 40% of the width of the inner cavity.

Preferably, said foam material is housed on the inner surface of the impermeable layer of the inner cavity of the tyre.

Preferably, the foam material can be housed in the cavity in the shape of a toroid, or in the shape of a strip with length equal to that of the impermeable layer, or in the shape of single segments assembled so as to cover the entire length of the impermeable layer.

### BEST MODE FOR CARRYING OUT THE INVENTION

Some embodiment examples are given below for purely illustrative non-limiting purposes.

The Applicant has made a comparison in terms of acoustic absorption in the frequency range between 180 and 300 Hz between a foam material commonly used in tyres and a series of foam materials according to the present invention.

The foam material for comparison (Conf) is marketed under the trade name Metzonor 023 and is produced by Metzler Schaum GMBH. In particular, the foam material for comparison in made of polyurethane with a density of 23 Kg/m³. In particular, the cells of the foam material for comparison have an average size ranging from 250 to 400 μm with a standard deviation ranging from 20% to 30%.

The foam material of the invention is made of polyurethane and is characterised by a density ranging from 10 to 15 Kg/m³ and cells having an average size ranging from 150 to 190 μm with a standard deviation ranging from 5% to 15%. In particular, three samples were tested according to the following invention characterised by the following cell dimension: 150 μm (EXP 1), 170 μm (EXP 2) and 190 μm (EXP 3).

The acoustic absorption test was performed according to the ISO 10534-2 standard at a frequency ranging from 180 to 300 Hz.

Table I shows the results of acoustic absorption tests indexed to the result obtained with the foam material for comparison.

TABLE I

| | Conf | Exp 1 | Exp 2 | Exp 3 |
|---|---|---|---|---|
| Acoustic | 100 | 340 | 300 | 240 |
| absorption | | | | |
| coefficient | | | | |

As can be seen from the values in Table I, in the frequency range between 180 and 300 Hz, the foam materials of the present invention ensure an acoustic absorption greater (from approximately two and a half times to three and a half times greater) than that of the foam material for comparison.

Since the acoustic waves at low frequency (180-300 Hz) are those that characterise the cavity resonance sound generated by the vibrations of the air under pressure, the above evidence shows that the foam material subject of the present invention is able to ensure a general abatement of the noise level coming from the tyre when it is running.

1. A tyre comprising an impermeable layer designed to ensure the sealing under pressure of the air contained in the inner cavity of the carcass and a foam material housed on the inside of said inner cavity; wherein said foam material has a porosity made up of open cells having an average size ranging from 150 to 190 μm with a standard deviation ranging from 5% to 15%; said foam material having a density ranging from 10 to 15 Kg/m³ and being made of polyester-based or polyether-based polyurethane.

2. (canceled)

3. (canceled)

4. (canceled)

5. A tyre according to claim 1, wherein said foam material occupies a volume ranging from 0.1 to 100% of the volume of the inner cavity.

6. A tyre according to claim 5, wherein said foam material has a thickness ranging from 10 to 200 mm and a width ranging from 10 to 100% of the width of the inner cavity.

7. A tyre according to claim 1, wherein said foam material occupies a volume ranging from 0.4 to 20% of the volume of the inner cavity.

8. A tyre according to claim 7, wherein said foam material has a thickness ranging from 20 to 30 mm and a width ranging from 20 to 40% of the width of the inner cavity.

9. A tyre according to claim 1, wherein said foam material is housed on a surface of the impermeable layer of the inner cavity of said tyre.

10. A tyre according to claim 1, wherein said foam material is housed in the cavity in the shape of a toroid, or in the shape of a strip with a length that is equal to the one of the impermeable layer, or in the shape of single segments that are assembled so as to cover the entire length of the impermeable layer.
